(19) United States
(12) Patent Application Publication
(10) Pub. No.: US 2007/0058058 A1
(43) Pub. Date: Mar. 15, 2007

(54) Method of reading pixel signals from a multiple staggered sensor

(76) Inventor: Chen-Ho Lee, Hsin-Chu (TW)

Correspondence Address: BERKELEY LAW & TECHNOLOGY GROUP, 1700NW 167TH PLACE, SUITE 240, BEAVERTON, OR, 97006, US

(21) Appl. No.: 11/468,788

(22) Filed: Aug. 31, 2006

Related U.S. Application Data
(63) Continuation of application No. 09/916,271, filed on Jul. 30, 2001.

(51) Int. Cl. H04N 5/335

(52) U.S. Cl. 348/294

(57) ABSTRACT

A method of reading pixel signals from a staggered sensor comprises providing the staggered sensor which comprises at least two linear image sensors, wherein a plurality of photocells of one linear image sensor are offset abutting with a plurality of photocells of the adjacent linear image sensor respectively. The pixel signals from the consecutive photocells of one linear image sensor are read out, without inserting the pixel signals form the other linear image sensor. The method provides quick video output especially for low-resolution definition.

### BACKGROUND OF THE INVENTION

1. Field of the Invention

The invention relates to a method of video output of staggered sensors for a high-speed image capture apparatus, and more particularly relates to a method of video output of linear staggered sensors for a high-speed scanner.

2. Description of the Prior Art

People have already recognized that charge coupled devices (CCDs) or CMOS devices may be advantageously utilized as photosensitive detector elements for any image capture apparatus, such as a scanner. It has been shown that many mutually independent CCDs can be formed on a single chip of semiconductor material, such as silicon. Nevertheless, for high line scanning resolution capability is demanded of some image capture apparatuses, integrated CCD detector arrays involve optically interlacing or stitching the photocell elements within several rows of a two dimensional integrated array to perform the scanning.

Typically, a sensor array comprises multitudes of equidistantly spaced and mutually independent CCD detectors in each of successive rows. More than enough resolution elements or pixels to provide a high resolution definition of a scan line are imaged onto a single row of detectors. However, a limited number of CCD detectors which may be formed in any one row of the sensor array is insufficient to obtain high resolution input scanning through the use of just one row of photocells. To perform high resolution input scanning despite the characteristically low line resolution capabilities of the sensor array, the photosensitive zones of the photocells are laterally staggered or offset form one another in the line scanning direction so that individual pixels from each scan line are separately imaged onto respective ones of the photocells in one or another of the rows for the sensor array.

For example, a staggered sensor array comprises at least two sensor rows: main sensor row and sub sensor row arranged in an offset form. Each sensor row comprises multitudes of aligned photocells. When all of the pixels of each scan line are detected with a predetermined number of frames, each of the photocells responds to spatially predetermined one of the pixels of each scan line. Shown in FIG. 1A, number 5 represents a first series of video signals p1, p2, p3, . . . , p8 responded by the photocells (the number is 8, for example) in the main sensor row. Number 10 represents a second series of video signals p1′, p2′, p3′, . . . , p8′ responded by the photocells (the number is also 8) in the sub sensor row. In FIG. 1B, number 15 represents a series of clock pulses applied to the staggered sensor array to shift or read out the data samples generated by the photocells of the main and sub sensor rows. Multiple clock pulses may be supplied per frame to serially read out the data samples from the photocells in successive rows of the staggered sensor array. For a high resolution definition of a scan line, the video signals p1, p2, p3, . . . , p8 are arranged interlacing with the video signals p1′, p2′, p3′, . . . , p8′, such as number 20 VOUT p1, p1′, p2, p2′, p3, p3′, . . . p8, p8′.

However, for a low resolution definition of a scan line, only the video signals of one of the main sensor row or the sub sensor row are necessarily outputted to an analog/digital converter of a scanner. Such an interlacing arrangement of p1, p1′, p2, p2′, p3, p3′, . . . p8, p8′ can slow down the scan rate of the staggered sensor array and further become a bottleneck for the scanner. Furthermore, unnecessary video signals result in the heavy loading on the analog/digital converter and further slow down the operation rate of the analog/digital converter. One of resolution is to speed up the rate of the analog/digital converter, but high cost is necessary. On the other hand, the speed-up rate of the analog/digital converter (or the staggered sensor array) can generate the problem of EMI.

### SUMMARY OF THE INVENTION

It is an object of the present invention to provide a method of video output of a staggered sensor. The video signals of multiple sensor rows in the staggered sensor are outputted in series instead of interlacing.

It is another object of the present invention to provide a method of high-speed video output of a staggered sensor for an image capture apparatus. The method provides high-speed video output especially for low-resolution definition of a scanned frame.

In the present invention, a method of reading pixel signals from a staggered sensor comprises providing the staggered sensor which comprises at least two linear image sensors, wherein a plurality of photocells of one linear image sensor are offset abutting with a plurality of photocells of the adjacent linear image sensor respectively. The pixel signals from the consecutive photocells of one linear image sensor are read out, without inserting the pixel signals form the other linear image sensor.

### BRIEF DESCRIPTION OF THE DRAWINGS

A better understanding of the invention may be derived by reading the following detailed description with reference to the accompanying drawings wherein:

FIGS. 1A-1B are schematic diagrams illustrating a video output of staggered sensor array in accordance with a prior art;

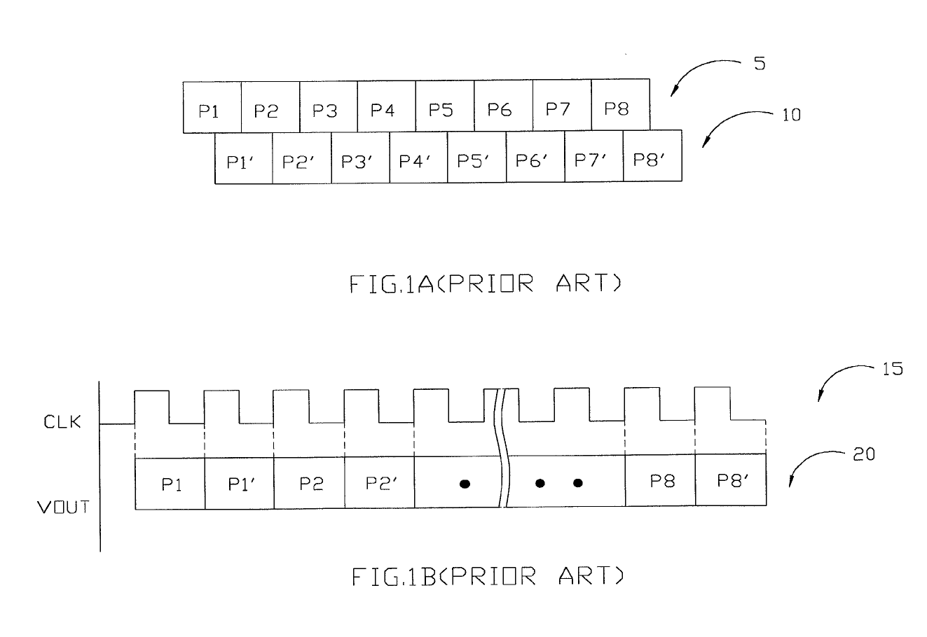

FIGS. 2A-2B are schematic diagrams illustrating a video output of staggered sensor array in accordance with the present invention;

FIG. 3 is a schematic diagram illustrating an embodiment of CMOS sensor in accordance with the present invention; and

FIG. 4 is a schematic diagram illustrating an embodiment of CCD sensor in accordance with the present invention.

### DESCRIPTION OF THE PREFERRED EMBODIMENT

While the invention is described in terms of a single preferred embodiment, those skilled in the art will recognize that many devices described below can be altered as well as other substitutions with same function and can be freely made without departing from the spirit and scope of the invention.

Furthermore, there is shown a representative portion of video signals of the present invention in enlarged. The drawings are not necessarily to scale for clarify of illustration and should not be interpreted in a limiting sense. Furthermore, the present invention can be applied on various image capture apparatuses, such as copier, MFP (Multiple-Function Product) or scanner.

In the present invention, a method of video output from a multiple staggered sensor array in a scanner. The method comprises providing at least two sensor rows in the multiple staggered sensor array, which each sensor row consists of a plurality of photo photocells. A scan line with a plurality of pixels is read by one of the sensor row to generate a first consecutive video signals. The scan line is then offsetting read by the other of the sensor row to generate a second consecutive of video signals. The video output is outputted which consists of at least the first consecutive video signals.

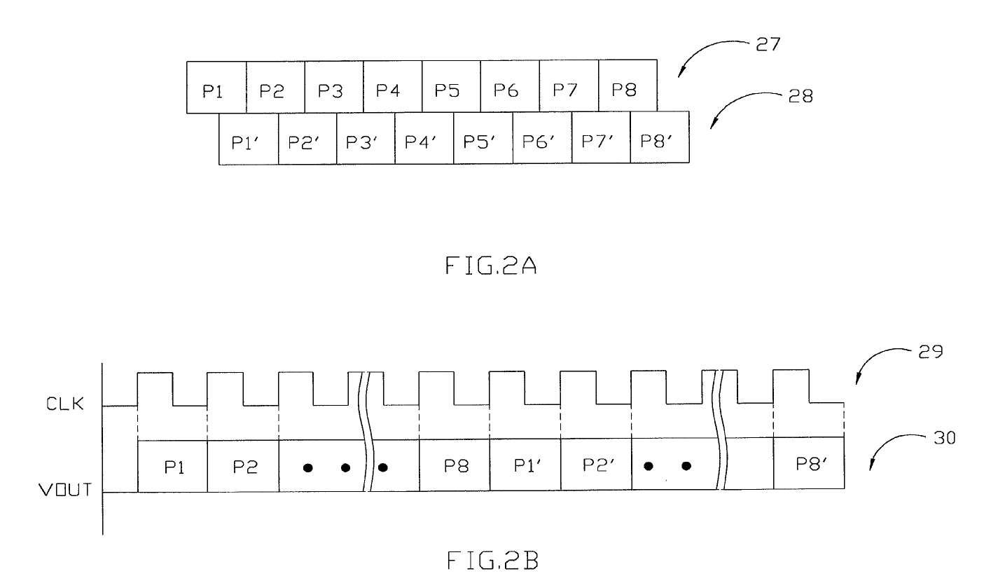

In an embodiment of the present invention, a double staggered sensor array is used in a high-speed scanner. The double staggered sensor array can be a color sensor array. Thus, the double staggered sensor array comprises a main sensor row and a sub sensor row wherein can consist of sub row for detecting various color. Each sensor row consists of 8 photo photocells. Shown in FIG. 2A, number 27 represents a first series of video signals p1, p2, p3, . . . , p8 responded by the photocells in the main sensor row. Number 28 represents a second series of video signals p1′, p2′, p3′, . . . , p8′ responded by the photocells in the sub sensor row. In FIG. 2B, number 29 represents a series of clock pulses applied to the double staggered sensor array to shift or read out the data samples generated by the photocells of the main and sub sensor rows. Furthermore, multiple clock pulses may be supplied per frame to serially read out the data samples from the photocells in successive rows of the double staggered sensor array.

When any resolution definition of a scan line, the present invention provides the video signals p1, p2, p3, . . . , p8 are arranged in series with the video signals p1′, p2′, p3′, . . . , p8′, such as number 30 VOUT p1, p2, . . . p8, p1′, p2′, . . . , p8′. Such in-sequence arrangement of p1, p2, . . . p8, p1′, p2′, . . . , p8′ is advantageous for low resolution that only the video signals of one of the main sensor row or the sub sensor row are necessarily outputted to the analog/digital converter. Thus, the output of the double staggered sensor array can speed up because the unnecessary video can be abandoned for saving output time. Furthermore, the present invention can be applied on the current hardware architecture of the scanner, only to change the data output sequence for the staggered sensor array, which can improve the speed of the scanner without high cost. The data output sequence can be adjustable by the related clock and counter circuit. Furthermore, the output of the double staggered sensor array can speed up without EMI problem on the scanner.

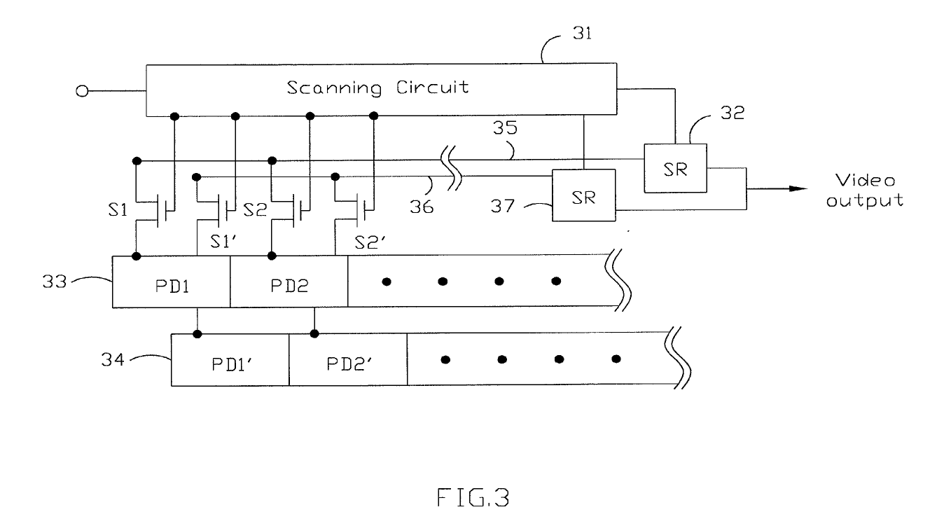

FIG. 3 is a schematic diagram illustrating an embodiment of CMOS sensor in accordance with the present invention. Main sensor row 33 consists of multitudes of photocells PD1, PD2, . . . , and so on. Similarly, Sub sensor row 34 consists of multitudes of photocells PD1′, PD2′, . . . , and so on. Each photocells of the main sensor row 33 is connected to one bus 35 through individual switch S1, S2, . . . and so on. The bus 35 is coupled to one shift register (SR) 32. Each switch S1, S2 . . . , is coupled to a scanning circuit 31 and controlled thereby. On the other hand, each photocells of the sub sensor row 34 is connected to the other bus 36 through individual switch S1′, S2′, . . . and so on. The bus 36 is coupled to the other shift register (SR) 37. Each switch S1′, S2′, . . . , is also coupled to the scanning circuit 31 and controlled thereby. In the embodiment, the scanning circuit 31 is enable to receive or generate a series of clock pulses or counter pulses to coordinate or control all of switches S1, S1′, S2, S2, . . . , and so on. Video signals from the photocells PD1, PD2, . . . , of the main sensor row 33 are outputted in sequence by the scanning circuit 31 controlling the switches S1, S2, . . . and so on. Similarly, video signals from the photocells PD1′, PD2′, . . . , of the sub sensor row 34 are outputted in sequence by the scanning circuit 31 controlling the switches S1′, S2′, . . . and so on. For the lower resolution definition, the scanning circuit 31 enables the video signals of the main sensor row 33 outputted first as a video output coupled to the analog/digital converter. The video output excluded from the video signals of the sub sensor row 34 can save time consumption for the scanner with definition of low resolution. On the other hand, the scanning circuit 31 enables the video signals of the main sensor row 33 in sequence outputted and followed by the video signals of the sub sensor row 34 in sequence when the high resolution is set for the scanner. There is no interlacing between the video signals of the main sensor row 33 and those of the sub sensor row 34. Thus, the video output included the video signals of the sub sensor row 34 can maintain the high resolution definition.

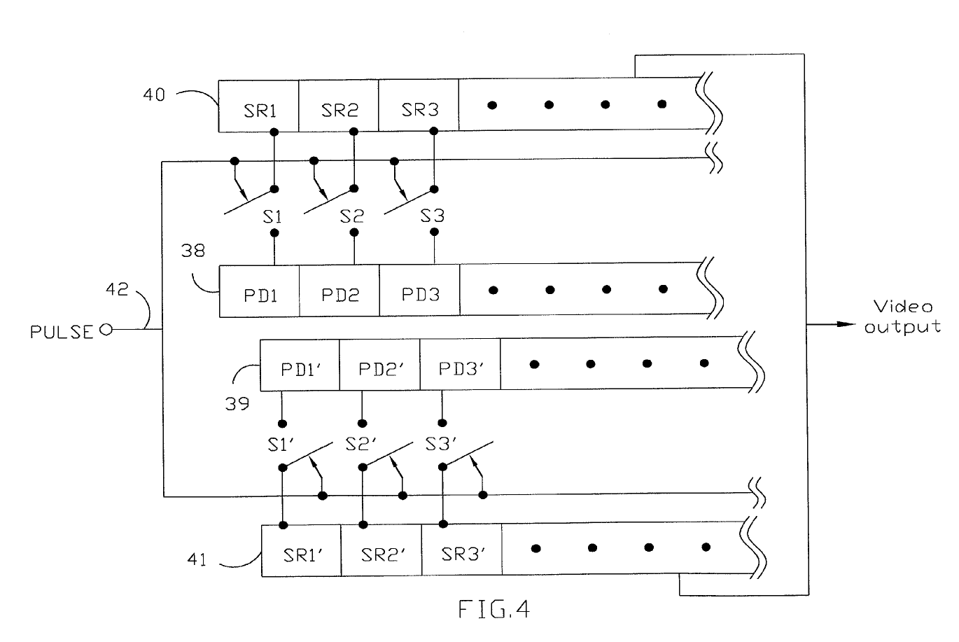

FIG. 4 is a schematic diagram illustrating another embodiment of CCD sensor in accordance with the present invention. The photocells PD1, PD2, . . . , are coupled to corresponded units (SR1, SR2, SR3, . . . ) of a shift register 40 through the switches S1, S2, S3, . . . , and so on. The switches S1, S2, S3, . . . , are controlled by the coupled pulse signals 42. On the other hand, the photocells PD1′, PD2′, . . . , are coupled to corresponded units (SR1′, SR2′, SR3′, . . . ) of another shift register 41 through the switches S1′, S2′, S3′, . . . , and so on. The switches S1′, S2′, S3′, . . . , are also controlled by the coupled pulse signals 42. The pulse signals 42 can include starting signal, clock signal, or counter signal, . . . , and so on. Thus, for low resolution, the video signals of the main sensor row 38 can be outputted first as the video output coupled to the analog/digital converter. For high resolution, the video output included the video signals of the sub sensor row 39 can maintain resolution performance.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1-11. (canceled)

12. A method of reading pixel signals from a staggered sensor, said method comprising:
generating pixel signals from said staggered sensor, said staggered sensor comprising at least two image sensors, wherein each of the at least two image sensors includes a plurality of photocells arranged in a substantially linear array, the at least two image sensors substantially abutting, photocells in one image sensor being offset from photocells in a second image sensor adjacent to said one image sensor, each photocell adapted to generate a pixel signal therefrom;
generating a first signal comprising pixel signals sequentially ordered in association with an ordering of the photocells in the one image sensor;
generating a second signal comprising pixel signals sequentially ordered in association with an ordering of the photocells in the second image sensor;
in response to a first resolution state, supplying said first signal without said second signal to an output; and
in response to a second resolution state, serially supplying said first signal followed by said second signal to said output.

13. The method of claim 12, wherein the first resolution state is of lower resolution than said second resolution state.

14. The method of claim 12, wherein the at least two image sensors include at least one charge-coupled device.

15. The method of claim 12, wherein the at least two image sensors include at least one metal oxide semiconductor sensing element.

16. The method of claim 12, wherein the method further comprises:
analog-to-digital converting signals supplied to said output.

17. The method of claim 12, wherein the signals from at least two image sensors are capable of producing a color image.

18. An image capture comprising:
staggered sensor adapted for generating pixel signals, said staggered sensor comprising at least two image sensors, wherein each of the at least two image sensors includes a plurality of photocells arranged in a substantially linear array, the at least two image sensors substantially abutting, photocells in one image sensor being offset from photocells in a second image sensor adjacent to said one image sensor, each photocell adapted to generate a pixel signal therefrom;
a scanning element adapted for generating a first signal comprising pixel signals sequentially ordered in correspondence with ordering of the photocells in the one image sensor, said scanning element adapted for generating a second signal comprising pixel signals sequentially ordered in correspondence with ordering of the photocells in the second image sensor, said scanning element responsive to a first resolution state and being adapted for supplying said first signal without said second signal to an output, and said scanning element responsive to a second resolution state and being adapted for serially supplying said first signal followed by said second signal to said output.

19. The method of claim 18, wherein the first resolution state is of lower resolution than said second resolution state.

20. The method of claim 18, wherein the at least two image sensors include at least one charge-coupled device.

21. The method of claim 18, wherein the at least two image sensors include at least one metal oxide semiconductor sensing element.

22. The method of claim 18, wherein the signals from at least two image sensors are capable of producing a color image.
